(19) United States
(12) Patent Application Publication
(10) Pub. No.: US 2006/0109464 A1
(43) Pub. Date: May 25, 2006

(54) Method for detecting alignment accuracy

(76) Inventor: Akiyuki Minami, Tokyo (JP)

Correspondence Address: RABIN & BERDO, P.C., Suite 500, 1101 14th Street, Washington, DC, 20005, US

(21) Appl. No.: 11/231,825

(22) Filed: Sep. 22, 2005

(30) Foreign Application Priority Data
Nov. 22, 2004 (JP) 2004-336969

(51) Int. Cl. G01B 11/00

(52) U.S. Cl. 356/401

(57) ABSTRACT

A method for checking with high accuracy the mismatch of two patterns by using a circuit pattern whose change in electrical resistance is highly sensitive to matching shifts. The method includes finding the amount of matching shift of a semiconductor device circuit pattern from the trend in the change in electrical resistance, and comparing the amount of matching shift with the measured value of an overlay measurement mark.

### BACKGROUND OF THE INVENTION

1. Field of the Invention

The present invention relates to a method for detecting alignment accuracy of circuit pattern overlay and the like in a semiconductor device manufacturing process.

2. Description of the Related Art

Semiconductor devices are formed by building one upon another a plurality of layer-shaped patterns. These patterns are often called “layers.” In order that these device patterns can serve in combination as an electrical circuit, it is necessary that layer-to-layer overlay be done with good accuracy.

A semiconductor device manufacturing process includes a film-forming step for forming a film on the wafer, a photolithography step for forming a photoresist pattern (i.e., a transferred circuit pattern image) on the prepared film, and an etching step for removing unnecessary portions of the film. The resist pattern functions as a blocking part during the etching step. In this manufacturing process it is the photolithography step that determines the accuracy of the overlay, and that accuracy is assured by measuring special marks which are called “overlay measurement marks.”

Overlay measurement marks are two marks formed in two layers, the lower layer and the current layer. These two marks are called the lower-layer mark and the upper-layer mark, respectively. The lower-layer mark is part of the lower layer, formed simultaneously with the device pattern when the lower layer is processed. The upper-layer mark is part of the photoresist formed simultaneously with the device pattern during the current photolithography step. By measuring the amount of shift between these two marks by means of an optical measuring device (hereinafter, overlay measuring device), the misalignment between the two layers can be found.

Obviously, it is desirable that the overlay accuracy found in this way accurately express the overlay condition of the device patterns. In actuality, however, it is known that the detected overlay accuracy does not precisely represent the actual overlay condition of the device patterns, due to the lens aberrations of the exposure equipment used in the photolithography step. Lens aberrations cause a Pattern-Placement-Error (hereinafter PPE) resulting in a position shift of the pattern imaged on the wafer. The amount of the PPE depends on the size and pitch of the pattern. Therefore, when an overlay measurement mark is used which has a size and pitch different from the device pattern under consideration, the overlay condition of the device patterns cannot be accurately expressed. This is undesirable in evaluating the device overlay matching, and it is desirable to grasp quantitatively the amount of this influence.

FIGS. 4A through 4C of the accompanying drawings show in combination a conventional method employed for finding the amount of measurement shift between the device patterns and the overlay measurement marks.

FIG. 4A shows a wafer 310 when the photolithography step for the second metal wiring is performed with a single damascene process. The wafer 310 has at least an inter-layer insulation film 320 and a film (or current layer) 330. The film 330 will be processed to a second metal wiring. The inter-layer insulation film 320 has a via pattern 321 formed at the time of forming the layer 330 and a lower-layer mark 322 which is an overlay measurement mark.

On the other hand, a photomask 350 has an aperture portion 351 which functions as the device pattern of the current layer and another aperture portion 352 which functions as the upper-layer mark of the overlay measurement marks. The pattern on the photomask 350 is imaged on the wafer 310 through a projection optical system 340 of the exposure equipment. A positive photoresist 360 is placed in advance on the wafer 310. After exposure, alkaline developing is performed on the positive photoresist 360. As a result, a photoresist aperture portion 361 which is the transferred image of the photomask aperture portion 351 is created, and another photoresist aperture portion 362 which is the transferred image of the photomask aperture portion 352 is created. The photoresist aperture portions 361 and 362 become located in positions shifted from where they should be, due to the PPE effect originating from the projection optical system 340.

FIG. 4B is a schematic plan view of the wafer 310. The upper surface of the wafer 310 is depicted. The aperture portion 361 (in the figure, the un-shaded line-shaped pattern) is located in a position shifted, for example, to the left of where it should be. The aperture portion 362 (in the figure, the un-shaded box-shaped pattern) is located in a position shifted, for example, to the right of where it should be.

The reason why the shift directions of the aperture portions 361 and 362 are different is because the pattern sizes of the aperture portions 361 and 362 are different from each other, and therefore the PPE effects on the aperture portions 361 and 362 are different from each other.

Because the width sizes of the lower-layer patterns 321 and 322 are the same in the pattern shift direction under consideration in the illustrated example, namely, the left-right direction in FIG. 4B, the PPE effect at the time of forming those patterns can be ignored.

Because the pattern size is extremely fine, namely on the order of 100 nm, the amount of device pattern shift created by the lower-layer pattern 321 and the aperture portion 361 is measured by means of an electron microscope such as SEM. In contrast, the amount of overlay measurement mark shift created by the lower-layer mark 322 and the upper-layer mark 362 is measured by means of an overlay measuring device.

In the illustrated example, the SEM is a high-acceleration voltage type SEM. The high-acceleration voltage type is used because the commonly used SEMs only obtain signals of secondary electrons from the wafer surface and thus cannot obtain an image of the lower-layer pattern 321. If the common SEM is used, therefore, a countermeasure is necessary. For example, a dedicated pattern copying the device is prepared and a substitute pattern of the lower-layer pattern 321 is formed in the photoresist 360, adjacent to the aperture portion 361, when the aperture portion 361 is formed. This enables observation of the lower-layer pattern 321. In the illustrated example, however, observation of the lower-layer pattern 321 is made possible through use of the high-acceleration voltage type SEM.

The amount of center shift between the lower-layer pattern 321 and the aperture portion 361, observed by means of the SEM, is indicated as ΔD. The amount of center shift between the lower-layer mark 322 and the upper-layer mark 362, observed by means of the overlay measuring device, is indicated as ΔM. In FIG. 4C, the horizontal axis indicates the ΔM, the vertical axis indicates the ΔD, and a plurality of data points within the wafer are plotted as a scatter diagram.

In the graph shown in FIG. 4C, if the shift amount of the aperture portion 361 is equal to that of the aperture portion 362, a straight line which passes through the origin of the graph is plotted (drawn). However, if there is a difference between the shift amounts of the two aperture portions, a line having a certain shift, as indicated by the segment 370, is plotted. This segment 370 represents the shift difference between the aperture portions 361 and 362. By finding this difference, the amount of mismatch between the device pattern and the overlay measurement mark can be found.

In the above-described conventional method, the amount of shift ΔD between the center of the lower-layer pattern 321 of the device pattern and the center of the aperture portion 361 is used as the evaluation index. Thus, the change in characteristics is linear as shown in FIG. 4C, which is somewhat obscure or unclear for the evaluation purpose. Therefore, the tolerance in respect to measurement errors is narrow and, as a result, it is difficult to obtain a high-accuracy determination.

Further, because the SEM is used (more specifically, because electronic lines are used), there are various factors which contribute to accuracy degradation. For example, as an indirect contributory factor, there is distortion and blurring of the observed image due to “charge up” of the object being measured. Also, there are various direct contributory causes such as contamination due to residual matter adhering inside the SEM mirror column; sputtering due to electron collisions (i.e., stripped off of some parts of the object being measured); material changes due to absorption of electron energy; and condition changes due to out-gassing under vacuum. In addition, throughput is low so that it is difficult to perform evaluation of numerous data.

Another conventional method for detecting alignment accuracy is disclosed in Japanese Patent Kokai (Laid-Open Application) No. 10-189678. This detects alignment accuracy from changes in resistance of the circuit patterns, but it cannot be said that the alignment is sufficient.

### SUMMARY OF THE INVENTION

One object of the present invention is to provide a new alignment accuracy detection method that enables highly accurate alignment.

According to one aspect of the present invention, there is provided an alignment accuracy detection method used when performing the alignment accuracy detection of a semiconductor device circuit pattern through changes in the electrical resistance of the circuit pattern. The alignment accuracy detection method includes the step of detecting the amount of circuit pattern position shift of the semiconductor device from the trend in change of electrical resistance of the circuit pattern. The alignment accuracy detection method also includes comparing the amount of circuit pattern position shift with the measured value of a second pattern. The second pattern is an alignment measurement mark. Thus, the alignment accuracy detection method finds with high accuracy the amount of mismatch between the two patterns, to perform circuit pattern alignment accuracy detection.

Because it becomes possible to utilize the abrupt change characteristics of resistance values, highly accurate alignment compared to conventional methods becomes possible. Because an SEM is not used, it also becomes possible to reduce accuracy degradation caused by electronic lines.

High throughput can be expected if a tester is used to measure resistance values. It becomes possible to further improve alignment accuracy by evaluating numerous data.

### BRIEF DESCRIPTION OF THE DRAWINGS

FIG. 1A to FIG. 1D is a series of diagrams to show creation of a pattern for measuring electrical resistance according to an embodiment of the present invention;

FIG. 2A to FIG. 2C is a series of diagrams to show creation of an overlay measurement mark, and FIG. 2A to 2C correspond to FIG. 1A to FIG. 1C, respectively;

FIG. 3A is a diagram that shows the characteristics obtained with the embodiment of the invention;

FIG. 3B is a diagram that shows the characteristics obtained with the prior art method; and

FIG. 4A to FIG. 4C is a series of diagrams to show the prior art method.

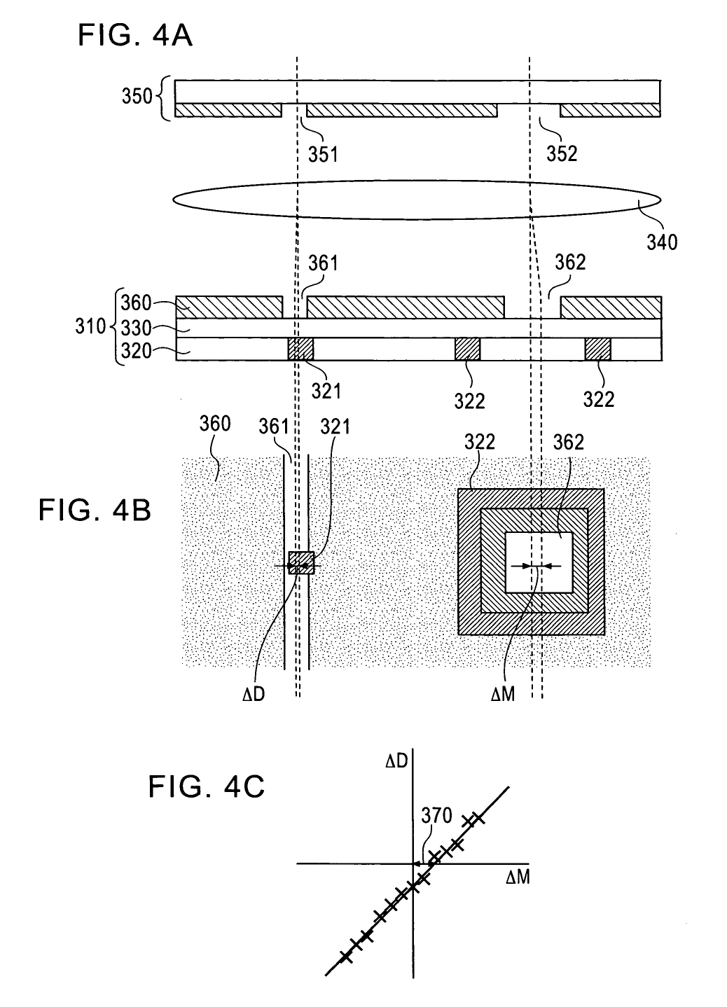

### DETAILED DESCRIPTION OF THE INVENTION

Below, an embodiment of the present invention is described with reference to the accompanying drawings.

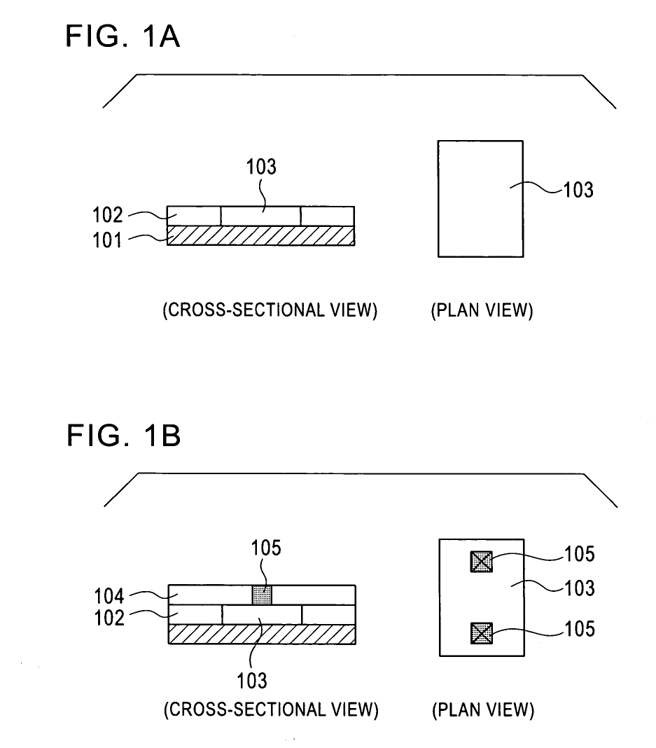

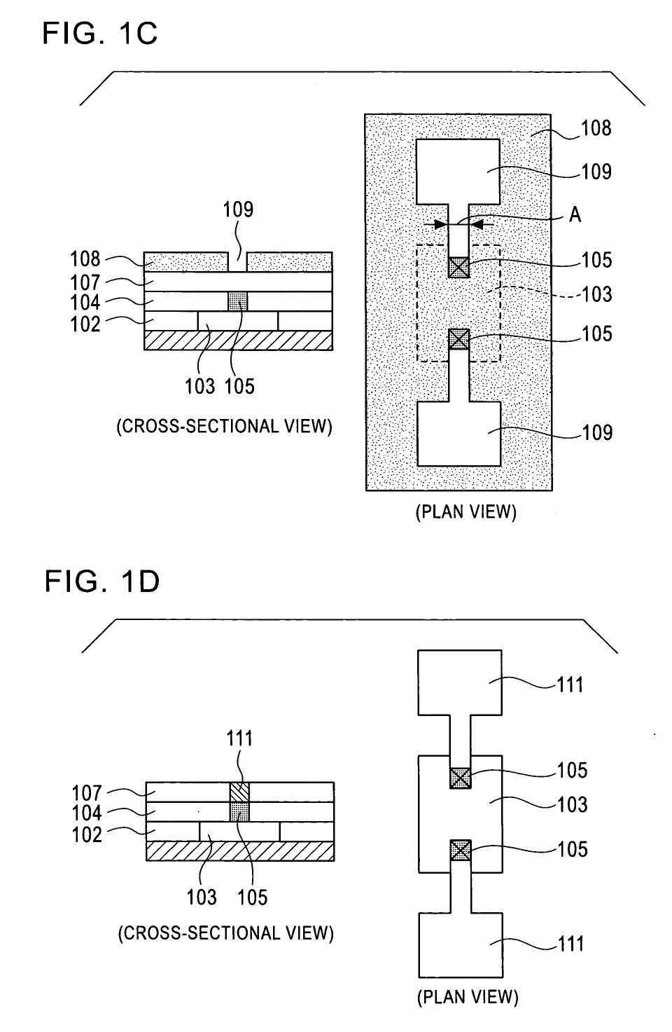

In this embodiment, the overlay shift condition of the lower-layer pattern and upper-layer pattern of the device is detected through electrical resistance. For measurement of electrical resistance, a dedicated electrical resistance measurement pattern is used. FIG. 1A to FIG. 1D and FIG. 2A to FIG. 2C show two series of processes used in the present embodiment to create the patterns. In broad terms, FIG. 1A to FIG. 1D is a series of flow diagrams of the creation of an electrical resistance measurement pattern, and FIG. 2A to FIG. 2C is a series of flow diagrams of the creation of an overlay measurement mark, which are performed when the processes of FIG. 1A to FIG. 1C are performed. Each diagram includes two illustrations; a cross-sectional view on the left and a plan view on the right.

FIG. 1A and FIG. 2A show the situation where an insulation film 102 is prepared on a semiconductor substrate 101. Then, a photolithography process, an etching process, and a damascene process are performed to form a first metal wiring 103. The first metal wiring 103 has an ample pattern spread so that a matching tolerance is ensured in respect to the vias which will be formed later.

It should be noted that in the overlay measurement mark portion (FIG. 2A) the pattern is not formed in the first metal wiring. Thus, FIG. 2A does not include a plan view diagram.

FIG. 1B and FIG. 2B show the situation where an interlayer insulation film 104 is prepared. Then, a photolithography process, an etching process, and a damascene process are performed to create a via 105. The via 105 is positioned having sufficient overlay tolerance in respect to the first metal wiring 103 which is the lower layer.

In the overlay measurement mark portion, a frame-shaped pattern 106 which functions as the lower-layer mark is formed with a width equal in size to the via 105.

FIG. 1C and FIG. 2C show the situation where an insulation film 107 for the second metal wiring is prepared, and a photoresist pattern 108 is formed through a photolithography process. In the device portion an aperture portion 109 which will be needed later when forming the second metal wiring is formed. For the shorter width A of the aperture portion 109, which contacts the via, the minimum dimension of the device is applied so that sensitivity to change in electrical resistance increases in respect to shifting in the match of the second metal wiring to the via.

The end of the aperture portion 109 on the side opposite the via has a large pattern so that it functions as a pad when electrical measurement is done. In the overlay measurement mark portion, an aperture portion 110 which functions as the upper-layer mark is formed. In the present structure, forming of the overlay measurement mark is completed and the amount of shift between the lower-layer mark 106 and the upper-layer mark 110 is measured by means of the overlay measuring device.

FIG. 1D shows the situation where another etching process is performed, and a second metal wiring 111 is formed by a damascene process. In this structure, forming of the electrical resistance measurement pattern is completed. Measurement of the resistance value is performed by means of a tester. Probes of the tester are brought into contact with the pad portions at the ends of the second metal wiring. In this embodiment, the minimum pattern size is used; there are only two vias. It should be noted, however, that the present invention can be applied when the chain pattern including the lower-layer metal wiring, the vias, and the upper-layer metal wiring has a larger scale.

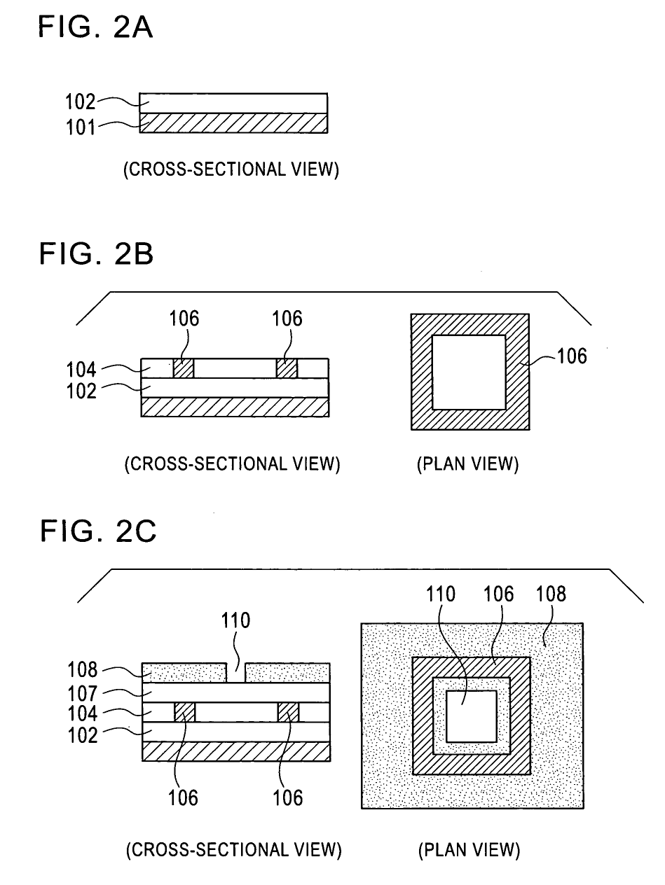

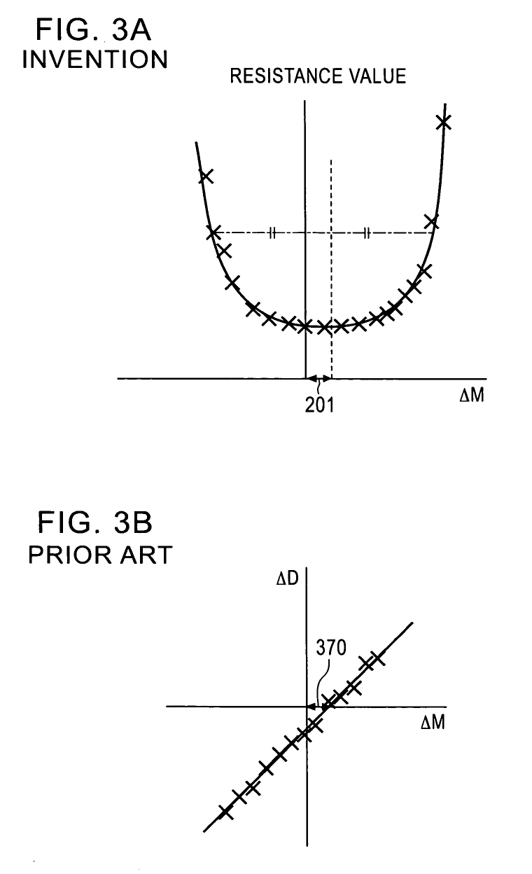

FIG. 3A and FIG. 3B are diagrams for comparison of the present embodiment method and the conventional method. FIG. 3A is a graph which shows the characteristics of the present embodiment. The figure plots, as a scatter diagram, the measured values of the overlay measurement marks on the horizontal axis and the resistance values of the electrical resistance measurement pattern on the vertical axis. In contrast, FIG. 3B is a graph showing the characteristics of the conventional method. The figure plots, as a scatter diagram, the measured values of the overlay measurement marks on the horizontal axis and the values of the shift in device pattern measured by the SEM on the vertical axis.

The difference in the two graphs is only the vertical axis parameter. Thus, if the amount of shift in the horizontal direction of the curve corresponding to the line segment 370 of the conventional method is found, this amount of shift is the amount of mismatch between the device pattern and the overlay measurement mark in the present embodiment. Because the shape of the electrical resistance measurement pattern is left-right symmetrical, the electrical resistance characteristics graph of FIG. 3A is also left-right symmetrical. It is possible to find from the symmetry of the graph a line segment 201 which is the amount of shift in the horizontal direction.

In the present embodiment, it is possible to utilize the abrupt change characteristic of the resistance values. Thus, highly accurate alignment becomes possible, compared to conventional methods. Since an SEM is not used, the method of the invention does not suffer from accuracy degradation caused by electronic lines.

This application is based on a Japanese Patent Application No. 2004-336969 filed on Nov. 22, 2004 and the entire disclosure thereof is incorporated herein by reference.

What is claimed is:

1. A method of performing alignment accuracy detection of a circuit pattern of a semiconductor device through changes in an electrical resistance of said circuit pattern, the method comprising:
finding an amount of position shift of said circuit pattern from a trend in change of the electrical resistance of said circuit pattern; and
comparing the amount of position shift of said circuit pattern with a measured value of an alignment measurement mark pattern, and thereby finding with high accuracy an amount of mismatch between the circuit pattern and alignment measurement mark pattern.

2. A method of forming an electrical resistance measurement pattern in a circuit pattern of a semiconductor device, the method comprising:
providing a semiconductor substrate;
forming a first insulation layer on the semiconductor substrate;
forming a first metal wiring in the first insulation layer;
forming a second insulation film over the first insulation layer and the first metal wiring;
forming at least two vias in the second insulation film;
forming a third insulation film over the second insulation film and the at least two vias;
forming a photoresist pattern over the third insulation film;
forming two aperture portions in the photoresist pattern such that the two aperture portions correspond to the at least two vias; and
forming a second metal wiring in the third insulation layer.

3. The method according to claim 2, wherein the first insulation layer is formed by a photolithography process, an etching process, and a damascene process.

4. The method according to claim 2, wherein the photoresist pattern is formed by a photolithography process.

5. The method according to claim 2, wherein a width of each said aperture portion which contacts the associated via is a possibly smallest value.

6. The method according to claim 2, wherein the second metal wiring is formed by an etching process and a damascene process.

7. The method according to claim 2, wherein the first metal wiring has a spread sufficient for matching tolerance with respect to the at least two vias.

8. The method according to claim 2, wherein the at least two vias are formed by a damascene process.
